(19) United States
(12) Patent Application Publication
(10) Pub. No.: US 2014/0122109 A1
(43) Pub. Date: May 1, 2014

(54) CLINICAL DIAGNOSIS OBJECTS INTERACTION

(71) Applicant: Consuli, Inc., San Diego, CA (US)

(72) Inventors: Reza Ghanbari, San Diego, CA (US); John Choi, Irvine, CA (US)

(73) Assignee: Consuli, Inc., San Diego, CA (US)

(21) Appl. No.: 14/066,532

(22) Filed: Oct. 29, 2013

Related U.S. Application Data
(60) Provisional application No. 61/719,766, filed on Oct. 29, 2012.

(51) Int. Cl. G06F 19/00

(52) U.S. Cl. CPC G06F 19/345
USPC 705/2

(57) ABSTRACT

A method for diagnosing a patient using a computer system includes, on the computer system: receiving information from the patient, the information including symptoms and symptom history; identifying a first set of diagnoses using the information; presenting the first set of diagnoses and a first set of questions to the patient in accordance with the information; receiving a first set of answers to the first set of questions; and identifying a second set of diagnoses and a second set of questions in accordance with the first set of answers.

### CROSS-REFERENCE TO RELATED APPLICATIONS

This application claims the benefit of U.S. Provisional Patent Application No. 61/700,309, “CLINICAL DIAGNOSIS OBJECTS AUTHORING,” filed in the United States Patent and Trademark Office on Sep. 12, 2012, the entire disclosure of which is incorporated herein by reference and the benefit of U.S. Provisional Patent Application No. 61/719,766, “CLINICAL DIAGNOSIS OBJECTS INTERACTION,” filed in the United States Patent and Trademark Office on Oct. 29, 2012, the entire disclosure of which is incorporated herein by reference.

### FIELD

Aspects of embodiments of the present invention relate to systems for diagnosing patients based on the medical diagnosis information collected from patients, and methods of operating such systems.

### BACKGROUND

In the field of medical diagnosis, medical professionals such as doctors and nurses generally diagnose a patient's disease by conducting patient interviews, performing physical inspections, obtaining samples for chemical or biological analysis, and classifying the patient's symptoms into a disease based on the medical professional's knowledge and experience and in conjunction with medical reference materials.

For example, during initial patient intake, a patient or their caretaker may complete paper forms to provide initial information such as the patient's main complaint, basic symptoms, medical history, and other personal information. A nurse or other medical professional may then process these forms to form an initial diagnosis and possibly to triage the incoming patients based on the urgency of the medical condition. In addition, a nurse may also use information provided by the patient to ask follow-up questions or to take an initial survey of various signs and symptoms and add this information to the patient's chart. If necessary, a doctor may later see the patient, review the charts, and perhaps order additional tests to be run.

By design, the forms initially completed by the patient are broad and generic in order to encompass the wide range of medical conditions that could be encountered in a clinical setting. However, in order to make the forms manageable (e.g., concise and understandable) by a wide range of patients, the forms are also generally quite shallow.

### SUMMARY

Embodiments of the present invention relate to a system and method for collecting information about and diagnosing patient medical conditions.

According to one embodiment of the present invention, a method for diagnosing a patient using a computer system including a processor and memory storing a plurality of instructions to be executed on the processor includes: receiving, on the computer system, information from the patient, the information comprising symptoms and symptom history; identifying, on the computer system, a first set of diagnoses using the information; dynamically presenting, from the computer system, the first set of diagnoses and a first set of questions to the patient in accordance with the information; receiving, on the computer system, a first set of answers to the first set of questions; and identifying, on the computer system, a second set of diagnoses and a second set of questions in accordance with the first set of answers.

The identifying the first set of diagnoses using the information may be performed using a neural network, a Bayesian network, or an expert system.

The method may further include detecting a patient engagement metric, wherein the patient engagement metric comprises an amount of time spent answering the first set of questions.

The method may further include displaying a final diagnosis and saving the first set of answers for further review if the patient engagement metric satisfies a threshold patient engagement level.

The method may further include generating an alerting alert a medical professional after detecting that the patient engagement metric satisfies the threshold patient engagement level.

The method may further include selecting the second set of questions in accordance with a preference of the patient determined from the first set of answers.

The second set of questions may include a narrative question or a direct question in accordance with the determined preference.

The first set of answers may include free form text.

The identifying the second set of questions may include selecting a question from a collection of questions in accordance with a likelihood that an answer to the selected question will distinguish between different ones of the second set of diagnoses.

The method may further include generating an alert when a confidence level in the second set of diagnoses satisfies a threshold confidence level.

According to one embodiment of the present invention, a system for diagnosing a patient, includes: a server including a processor and memory storing instructions configured to be executed on the processor and to cause the server to: receive information from the patient, the information including symptoms and symptom history; identify a first set of diagnoses using the information; dynamically present the first set of diagnoses and a first set of questions to the patient in accordance with the information; receive a first set of answers to the first set of questions; and identify a second set of diagnoses in accordance with the first set of answers, the second set of diagnoses being a subset of the first set of diagnoses.

The system may be configured to identify the first set of diagnoses using the information is performed using a neural network, a Bayesian network, or an expert system.

The instructions may further include instructions configured to be executed on the processor and to cause the server to: detect a patient engagement metric, wherein the patient engagement metric includes an amount of time spent answering the first set of questions.

The instructions may further include instructions configured to be executed on the processor and to cause the server to: display a final diagnosis and saving the first set of answers for further review if the patient engagement metric satisfies a threshold patient engagement level.

The instructions may further include instructions configured to be executed on the processor and to cause the server to: generate an alert after detecting that the patient engagement metric satisfies the threshold patient engagement level.

The instructions may further include instructions configured to be executed on the processor and to cause the server to: identify a second set of questions in accordance with a preference of the patient determined from the first set of answers.

The second set of questions may include a narrative question or a direct question in accordance with the determined preference.

The second set of questions may be identified by selecting a question from a collection of questions in accordance with a likelihood that an answer to the selected question will distinguish between different ones of the second set of diagnoses.

The first set of answers may include free form text.

The instructions may further include instructions configured to be executed on the processor and to cause the server to generate an alert when a confidence level in the second set of diagnoses satisfies a threshold confidence level.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a schematic diagram of a system for operating a medical diagnosis platform according to one embodiment of the present invention.

FIG. 1B is a schematic block diagram of a system for operating a medical diagnosis platform according to one embodiment of the present invention.

FIG. 2 is a flowchart illustrating a method of diagnosing a patient using a computer system according to one embodiment of the present invention.

FIGS. 3A, 3B, 3C, 3D, 3E, and 3F are schematic illustrations of an interface for answering questions for supplying medical information according to one embodiment of the present invention.

FIG. 4 is a flowchart illustrating a method of diagnosing a patient using a computer according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Generally, symptoms alone, such as “fever,” “headache,” and “nausea” that would generally be collected from a patient during initial intake have very little specificity. The nuanced patterns of these symptoms including their character, intensity, and time course are significant portions of the diagnosis.

However, patients working alone often do not have the medical expertise to use precise language or to quantify a symptom with sufficient details for a high quality diagnosis. As such clinicians use their training and experience to adjust aspects of their approach to elucidate more detailed symptomology. For example, clinicians may alter the phrasing of their questions or alter their conversational styles to match their patients' preferred interaction styles.

Embodiments of the present invention make use of human interface technologies such as voice recognition, natural language processing, and smart screen touch controls and combine them with computing technologies such as artificial intelligence, intelligent agents, and learning systems to dynamically create a diagnosis and to provide improved medical treatment experiences for patients. In addition, embodiments of the present invention can detect patient behavior and preferences in order to dynamically modify strategies for interacting with patients.

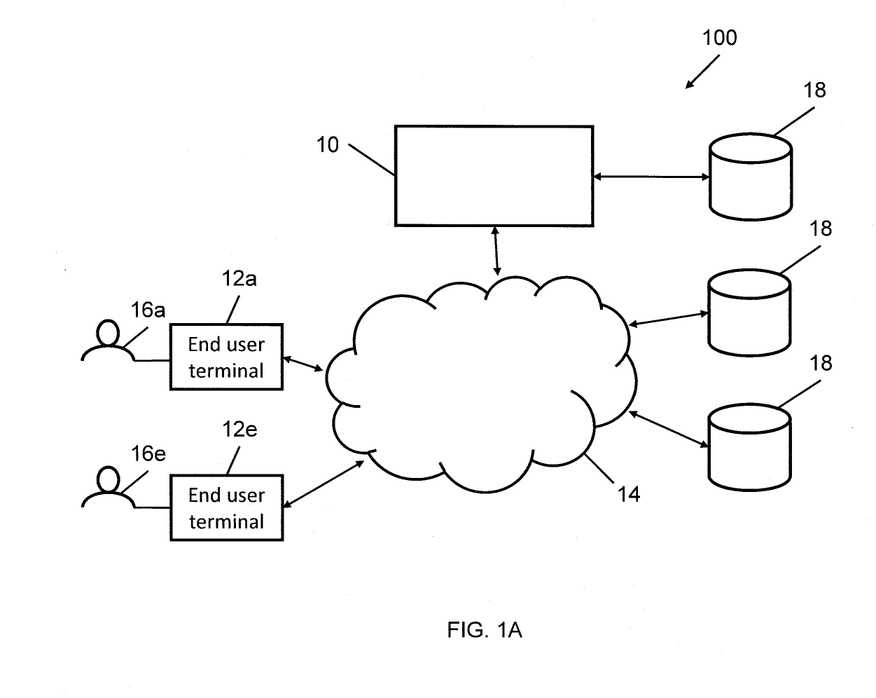

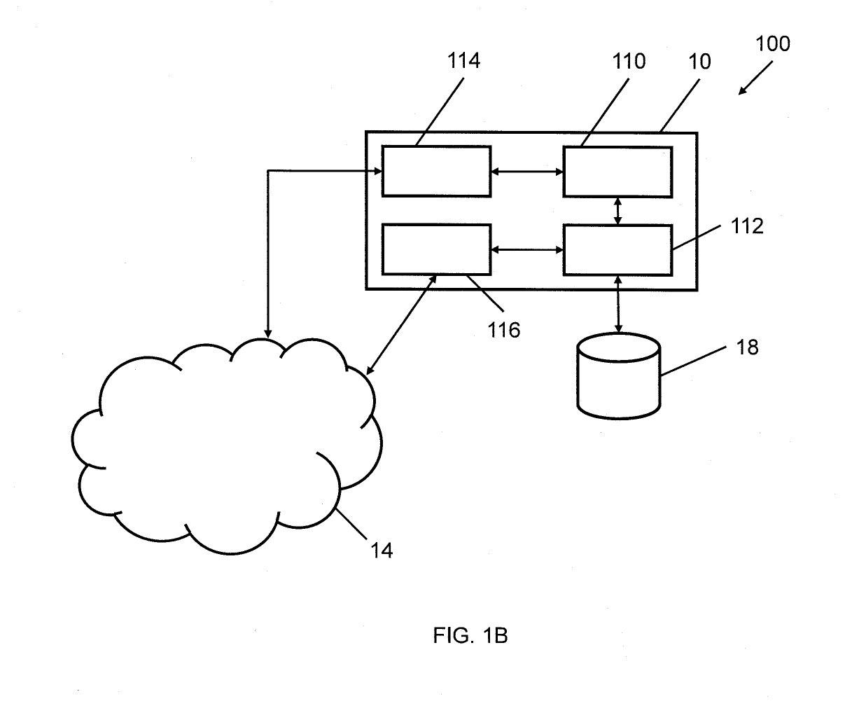

FIG. 1A is a system block diagram illustrating a system 100 for implementing a clinical diagnosis system according to one embodiment of the present invention. According to one embodiment of the present invention, the system may be implemented using an electronic database 18 (e.g., SQL databases such as MySQL®, PostgreSQL, and Microsoft® SQL Server® and NoSQL databases such as Apache Cassandra and MongoDB®) and the user interfaces may be provided via a web server 10 serving data to a web browser running on an end user terminals 12a and 12e using well known web technologies (e.g., serving pages written in HTML and JavaScript as served by web server software such as Apache, Microsoft® IIS, and Nginx™). However, embodiments of the present invention are not limited to web-browser based interfaces. The end user terminals 12a and 12e may be any of a variety of computing devices including tablet computers such as the Apple® iPad®, a laptop or desktop computer, a smartphone, or a personal digital assistant (PDA). The users 16 using the end user terminal 12a may include doctors, nurses, patients, and system database editors. The web browser may be connected to the web server over a network 14 such as, but not limited to, a private intranet, the public Internet, a virtual private network (VPN) connection, etc.

According to one embodiment of the present invention, the web server 10 and the end user terminals 12a and 12e are computing devices including a processor and memory storing instructions to be executed by the processor. The processor also includes input and output capabilities for communicating with computer networks using a variety of protocols (e.g., TCP/IP over Ethernet and WiFi networks, for receiving user input from input devices (e.g., touchscreens, keyboards, mice, etc.), and for displaying information on a display device (e.g., touchscreens, LCD panels, OLED panels, CRT monitors, etc.).

For the sake of convenience, the end user terminals will 12 be described in the context of tablet computers running web browsers to access a service processing information received from and providing information to user terminals 12 over a web-browser based interface. However, embodiments of the present invention are not limited thereto. For example, in some embodiments of the present invention, a separate application or “app” running on the end user terminal 12a or 12e may be used to access the electronic databases 18 via a server 10 which may be accessed using an application programming interface (API). In still other embodiments of the present invention, substantial portions of the data and application logic may be stored locally on the end-user terminals 12a and 12e and may be periodically or occasionally synchronized with the server 10 and the databases 18, or which may operate in an “offline” mode, independent of any persistent or regular connection to a server 10.

As used herein, the terms “computer,” “processor,” and “memory” may refer either to a single piece of physical hardware, or multiple pieces of hardware, whether physical or virtualized. For example, the server 10 may be a cluster of computers performing different functions and connected to each other by a network to perform the functions described herein and can be collectively referred to herein as a “computer.”

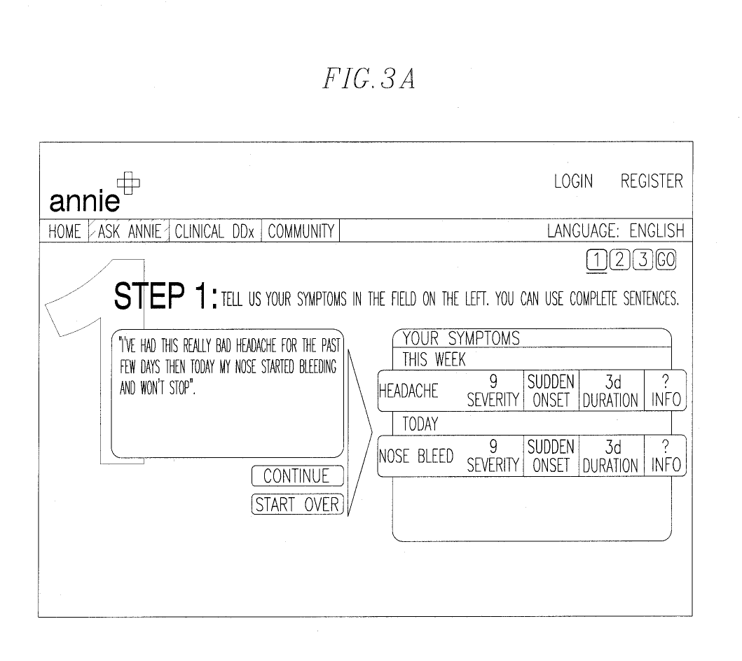

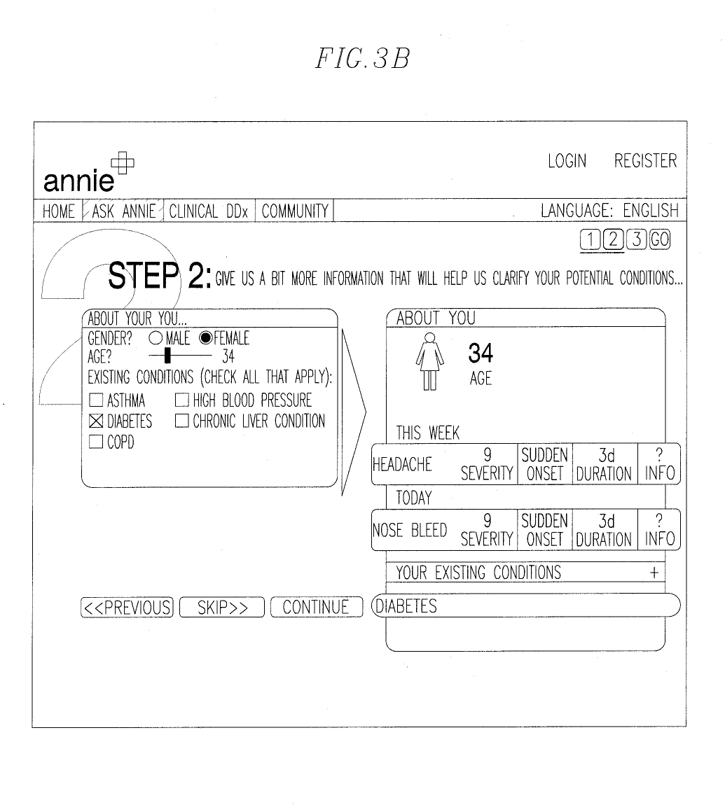

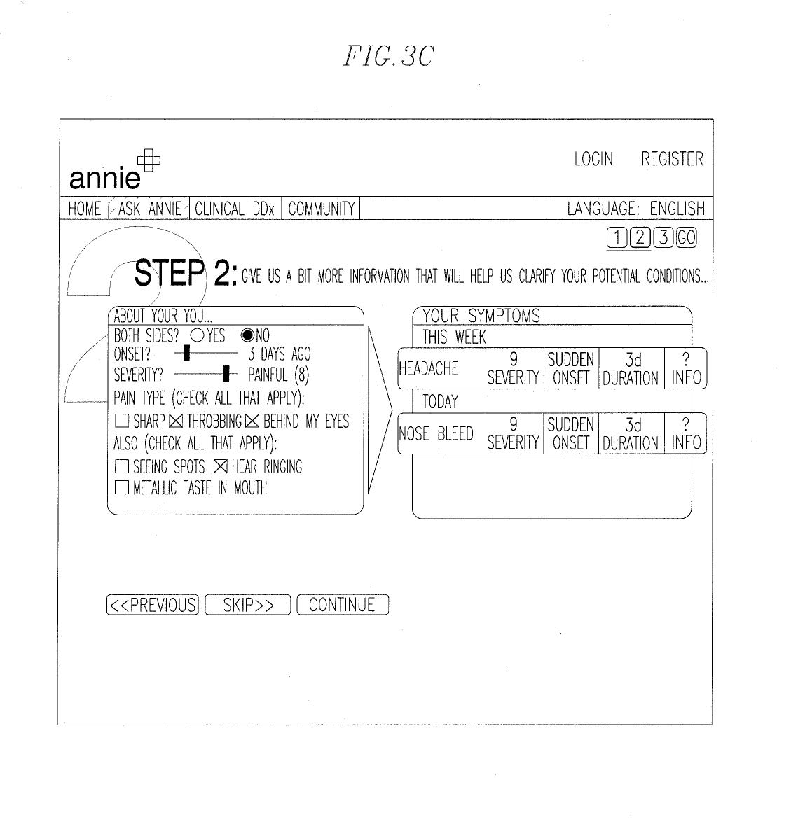

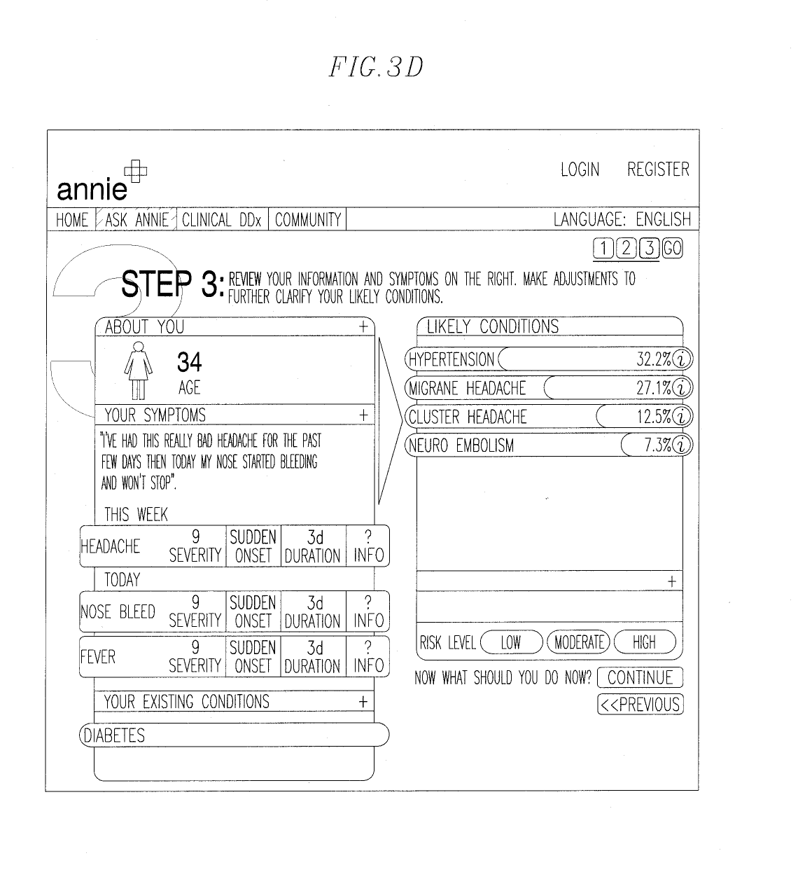

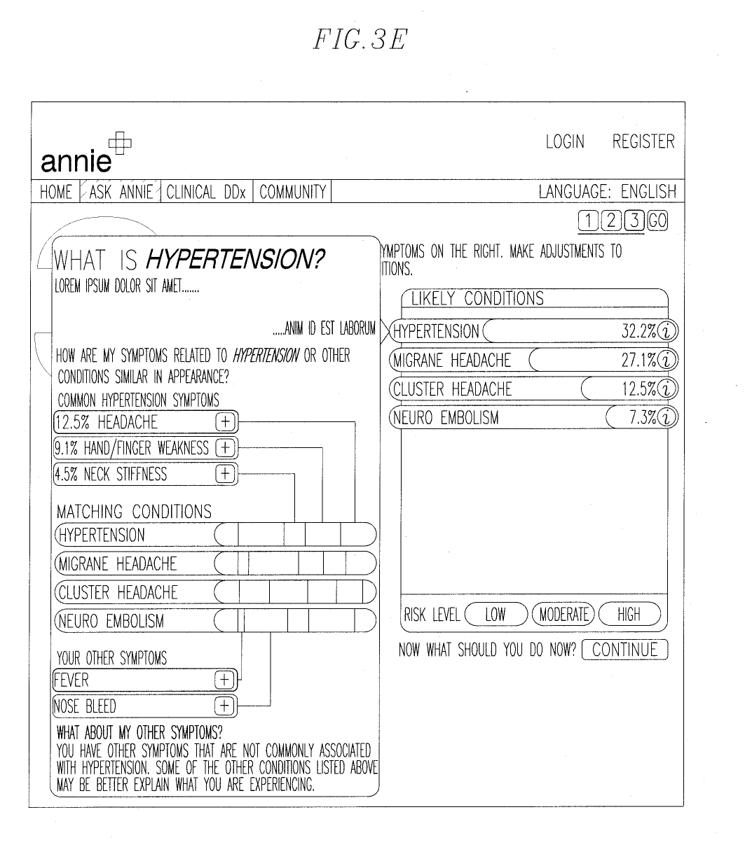

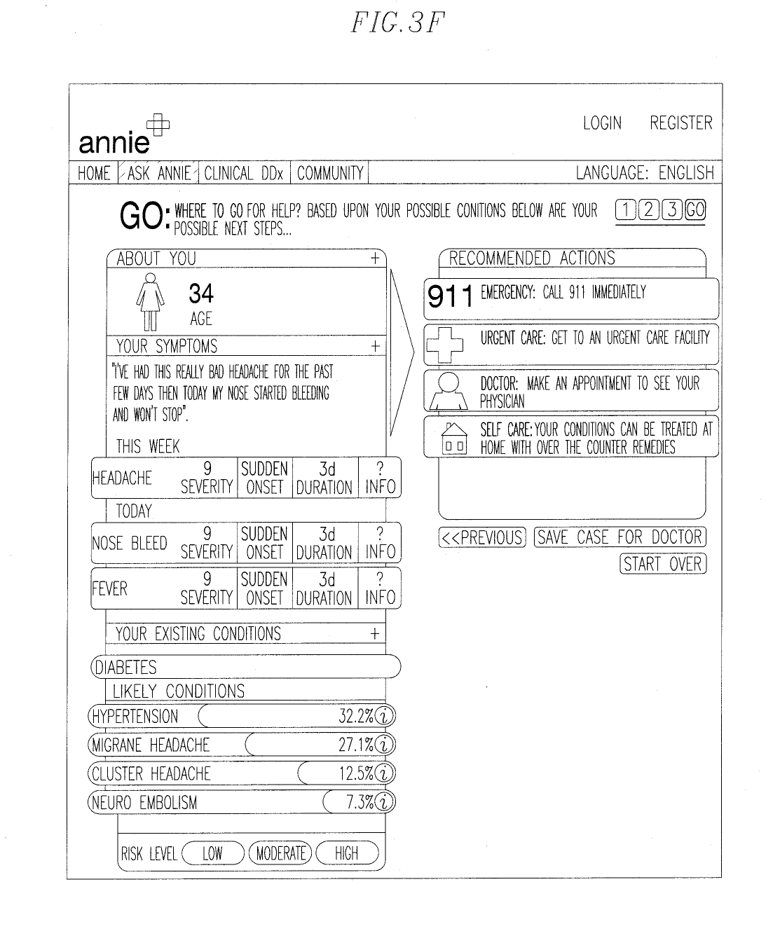

According to one embodiment, end user terminals 12a are supplied in the form of tablet computers such as the Apple® iPad® in waiting rooms in place of or as a supplement to traditional paper-based forms. In such embodiments, patients may enter information directly into the system 100 by answering questions regarding their personal information, medical condition, and symptom history through a user interface similar to that depicted in FIGS. 3A, 3B, 3C, 3D, 3E, and 3F.

FIG. 1B is a schematic block diagram of the system 100 for operating a medical diagnosis platform according to one embodiment of the present invention. The system 100 includes a model 110, a model trainer 112 configured to train and to update the model 110, a clinical user interface 114 configured to access the model, and a model editing user interface 116 configured to control the model trainer 112 and to edit the model 110. The model trainer may be configured to read the data stored in the database 18 to serve as an input for training or developing the model 110.

According to one embodiment, the clinical user interface 114 provides a web based user interface configured to receive inputs supplied by an end user 16a (e.g., a patient, a nurse, or a doctor) and to supply these inputs to the model 110. The model 110 processes the input and generates information to be returned to the end user 16a via the clinical user interface 114. In some embodiments, the clinical user interface 114 provides an application programming interface (API) such as a representational state transfer (REST) interface or simple object access protocol (SOAP) interface to receive and return information to an application running on an end user computer 12a (e.g., an application running on a tablet computer or phone).

According to one embodiment, the model 110 is generated by the model trainer 112, which uses information stored in the database 18 and provided by an expert user (e.g., a nurse, a doctor, and other medical professionals) via the model editing user interface 116 to generate a model of diseases. More information regarding the generation of these models can be found, for example, in U.S. patent application Ser. No. 14/025,735 “CLINICAL DIAGNOSIS OBJECTS AUTHORING” filed in the United States Patent and Trademark Office on Sep. 12, 2013, the entire disclosure of which is incorporated herein by reference.

In the embodiment shown in FIG. 1B, the various modules (including the model 110, the model trainer 112, the clinical user interface 114, and the model editing interface 116) are shown as components within server 10. However, in other embodiments of the present invention, multiple physical or virtual servers may be used to implement the functionality of the various modules. For example, the clinical user interface 114 and the model editing user interface 116 modules may be provided by one or more physical or virtualized web servers and the model 110 and the model trainer 112 may be modules provided by a one or more physical or virtualized back-end computer systems.

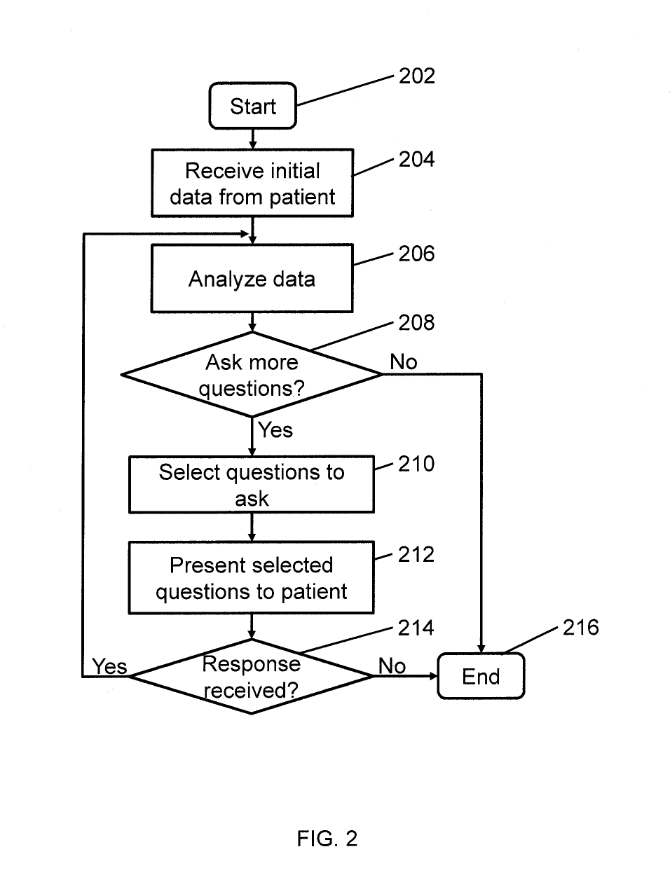

Referring to FIG. 2, according to one embodiment of the present invention, a process for using a computer system to diagnose a patient in accordance with information received from a patient may include: receiving initial data from a patient 204, analyzing the data 206, determining if there are additional questions to ask 208; if so, selecting questions to ask 210; presenting the selected questions to the patient 212; determining if a response is received 214; if so, looping and analyzing the additional data in the context of previously received data 206; if there are no additional questions to ask in operation 208 or if the patient does not respond to the prompts for additional questions and causes a timeout in operation 214, then the process ends 216. When the process ends at 216, the recorded data may be saved for further review by another party such as a nurse or a doctor.

For example, referring to FIG. 3A, and operation 204 of FIG. 2, a patient may first be asked a “what seems to be the problem?” question in which the patient may express their symptoms in their own words (typed or dictated) on a tablet, by phone, by SMS, by computer, or other electronic device. The system may also request additional information from the user such as sex, age, and existing conditions (see, e.g., FIG. 3B).

In operation 206, the server 10 analyzes the patient's response using a natural language processing (NLP) system to extract key symptoms and aspects of those symptoms such as severity, frequency, duration, type, etc. while the patient speaks and/or types. The NLP system detects symptoms and characteristics of those symptoms while the patient enters the data and updated the display on the end-user terminal 12 in real-time based on the extracted information. NLP leverages medical ontologies to recognize key sympotomic concepts, and analyzes the text around these symptoms for aspects to annotate those symptoms. For example, if a patient entered: “severe headache that started 3 days ago,” then in one embodiment, the NLP system would identify the word “headache” to classify one symptom as being a headache, detect “severe” as being near “headache” and apply the “severe” aspect to the diagnosis and create a temporal map identifying the headache as having started 3 days ago. The symptom (“headache”) is detected using medical concept dictionaries that provide a semantic map from particular words and phrases to medical concepts. For example, a medical concept dictionary could include entries such as “head hurts→headache” and “head throbbing→headache”. The characteristics of the detected symptom (“severe” and “three days ago”) are detected based on parsing sentence structure and relating modifiers to the identified symptoms.

In embodiments of the present invention, the parsing and recognition of the description is performed in real-time as the patients enter information, thereby allowing patients to adjust their language and explanations so that the computer recognizes what they mean. Embodiments of the present invention may also allow a user to delete or modify the recognized concepts, for example, to correct errors in the identification of concepts.

The server 10 analyzes the data in operation 206 to identify likely potential diagnoses and determines if additional information is needed in operation 208. The analysis may use any of a variety of well-known pattern matching systems for associating a given input with a particular result. In embodiments of the present invention, these systems may implement a machine learning algorithm such as a neural network, a Bayesian network, or an expert system. For example, based on the symptoms and details about the symptoms, embodiments of the present invention perform statistical analysis (such as statistical inference) to compare against the diagnostic “fingerprint” of all the disease objects in the system. Embodiments of the present invention produce a stacked rank of possible diagnoses based on how closely the symptoms match the fingerprints, with a likelihood score and confidence score for each. Based on the stacked rank, embodiments of the present invention may infer clarifying questions that would most statistically differentiate between the possible diagnoses on the differential diagnosis list. Accordingly, on the most relevant clarifying questions would be presented to the patient and questions that would be less useful in differentiating between the identified likely diagnoses would not be presented, thereby reducing the number of questions that will be asked of the patient. These clarifying questions can then be presented to the patient.

According to one embodiment of the present invention, analytic techniques similar to those used for performing the diagnoses are used to infer next best question. The diseases in the model 110 are represented by “disease objects” and each disease object has evidence and weights associated with it. When starting with a candidate list of possible diagnoses and a set of known evidence about the patient (e.g., the symptoms entered thus far), the system 100 can perform a “what if” analysis to assess what the impact of each unknown piece of evidence on the confidences of the remaining diagnoses. Sorting the list of unknown evidence based on impact on diagnosis confidence generates a prioritized list of evidence to ask for. When new evidence is provided (e.g., in response to a question presented by the system 100), the system 100 recalculates the confidences of the candidate diagnoses in accordance with the new evidence, and recalculates the next best question by performing the “what if” analysis on the remaining unknown evidence.

This targeted set of clarifying questions may ask about topics such as relevant aspects of patient history, additional symptom details, inquiries about other possible symptoms, etc. that would likely to help distinguish between the identified likely diagnoses (see, e.g., FIG. 3C). For example, an adult patient complaining of a severe itch in particular areas of the body may be asked if he or she had ever contracted chicken pox as a child to evaluate the likelihood of a diagnosis of shingles or may be asked about recent contact with plants such as poison oak. As another example, if system has access to clinical history for patient, the system may also confirm history that would have a significant impact on diagnosis (e.g., “I understand you have diabetes?”) and asks for additional history that would have a significant impact on diagnosis (e.g., “Have you traveled internationally in the last 2 months? If so, where?”).

If no additional information is needed (for example, if the system determines that a confidence level in the set of identified diagnoses corresponding to the provided information reaches or exceeds a threshold confidence level), then the process ends in operation 216. However, if there are additional questions to ask, the server 10 selects additional clarifying questions to ask in operation 210 and presents the additional questions to the patient using the end-user device 12 in operation 212.

The system can then receive the patient's responses to these additional clarifying questions in operation 214. If a response is received, then the additional data is analyzed is operation 206.

The system may present the relevant history and symptoms, along with a dynamic differential diagnosis of the patient's condition based on their history and inputs (see, e.g., FIG. 3D), which may also include a rating of the system's confidence in any particular diagnosis. This rating system and dynamic differential diagnosis can be updated in real time as the patient enters, updates, or changes his or her answers to the questions presented by the system. For example, the patient may modify their representations of their symptoms such as the order in which symptoms appeared or the time at which the pain changed in character (e.g., from dull to sharp). In some embodiments, sliders and other graphical interfaces may be displayed and manipulated for entering and updating answers to questions (e.g., a colored slider for pain scale).

If the patient would like additional information about any particular diagnosis, he or she may use the end-user device 12 to view more information about that disease and how their symptoms map to that diagnosis and what other symptoms would confirm or reject that diagnosis.

Based on history of interaction with the patient or some questions designed to determine their communication style, the system may adapt its follow-up and diagnosis refinement approaches to match how the patient may best expresses himself or herself. For example, the questions can be tailored based on the language spoken by the patient, the level of medical knowledge and familiarity with the disease (e.g., more colloquial or specialized language), and whether the patient responds better to more narrative questions or more direct questions (e.g., yes/no or selecting answers from a list). In some embodiments, over time, the system accumulates a library of interaction mechanisms and an associated library of patient types and patient information for generically matching patients with patient types in order to select interaction mechanisms appropriate for the patient type. For example, knowledge that patients have previously been treated for a particular disease may allow the system to use more specialized language when asking questions about the patient's current symptoms as they relate to that disease.

By measuring patient focus and/or fatigue, the system may detect when changes in interview approach or question style should be made in order to keep the patient engaged. Because different people will have different levels of patience for working through computer-based interviews, the system may dynamically decide when it is time to terminate the interview process and escalate to a clinician such as a nurse or a doctor based on measurements of patient engagement and comparisons of patient engagement to a threshold engagement value. For example, the rate at which a patient responds to questions may be used to estimate patient engagement. In addition, patient idle time on the device may also be used to monitor patient engagement. For example, if a patient completely stops responding to questions, the system may detect a timeout and end the process in operation 216. The system may also dynamically decide to terminate the interview process if there are no additional questions to be asked.

The escalation thresholds may also be adapted based on staff availability. For example, according to one embodiment, the system may also track availability of staff and, if a nurse is available, the patient may immediately receive a prompt indicating that the interview may be continued with the nurse. Alternatively, if the clinical staff is very busy, the system may also ask if the patient would be interested in answering additional, more detailed questions while waiting.

According to one embodiment, at the termination of the process, the system may present a list of likely diagnoses along with a summary of the data entered by the patient and a list of recommended actions. For example, if the patient is using the system from home, the list of recommended actions may include calling an emergency line, going in to urgent care, making an appointment to see a physician, and/or options and steps for self-administered diagnostics or treatment. Alternatively, if the patient is using the system from a hospital waiting room, the list of recommended actions may include immediately contacting a nurse in a priority line, continuing to wait in the regular line, or purchasing over-the-counter treatments.

At the end of the process, all the patient entered information is available to the clinician (nurse and/or doctor) to review, verify, refine, and make a final diagnosis (or the patient may be referred to the appropriate care giver and access method). For example, in a waiting room, patient may use a tablet to work through this question and answer process and then pass the tablet to the admitting nurse for refinement of the information (e.g., clarification). The nurse may pass the information on to the physician to review prior to seeing the patient and to reference and update the information as they are working with the patient. In other embodiments of the present invention, separate computing devices are used by each party and the patient information is accessed from one or more servers over a local area network or over the internet.

As another example, when contacting a nurse triage phone bank or call center, a patient may work through the questionnaire on a tablet or on the web using a web browser. According to one embodiment, the patient's information is assigned an identifier (e.g., a session identifier or associated with a patient identifier). By loading the information associated with the patient, the triage nurse would then have a case work-up and recommended protocols available to them when they started chatting with patient on the phone or over text-based chat or instant messages.

In addition, according to one embodiment, information collected from the patients by the system may be used to automatically triage patients based on the severity of their conditions. For example, patients reporting chest pain in a manner consistent with a heart attack would be given priority over patients reporting chest pain in a manner consistent with acid indigestion.

FIGS. 3A, 3B, 3C, 3D, 3E, and 3F are schematic illustrations of an interface for answering questions for supplying medical information according to one embodiment of the present invention. According to embodiments of the present invention, a user-friendly interface for inputting data is tuned to adapt to the medical condition being diagnosed and to the consumer's medical literacy, consumer literacy, and patience with the task of answering questions. FIGS. 3A, 3B, and 3C are schematic illustrations of questions that the system asks of patients during multiple steps of a patient intake process. FIG. 3D is a schematic illustration of a summary of the information supplied by the patient along with likely diagnoses based on the supplied information. FIG. 3E is a schematic illustration of an overlay to present more information about one of the likely diagnoses (in the example shown, information is shown regarding the diagnosis of “hypertension”). FIG. 3F presents a further summary of the likely diagnoses and recommended next actions, such as calling 911 in the event of an emergency and saving the supplied information for review by a doctor.

Embodiments of the present invention may receive information from patients using voice and/or typed text information which may be processed using natural language processing (NLP) techniques. The NLP processed input may be converted into widgets and other graphical depictions of the data, with a focus on depicting portions of the data that are relevant to the individual and his or her condition.

In some embodiments of the present invention, members of the medical staff such as nurses and doctors may review the information supplied by the patient on screens similar to those shown in FIGS. 3A-3F, but adapted for use by medical professionals. For example, the information supplied by the patient such as symptoms, duration, and history may be displayed using standard medical terminology rather than more colloquial or lay terms. In addition, as described above, potential lab tests, physical examinations, and other procedures may be suggested in accordance with the role and level of training of the member of the medical staff.

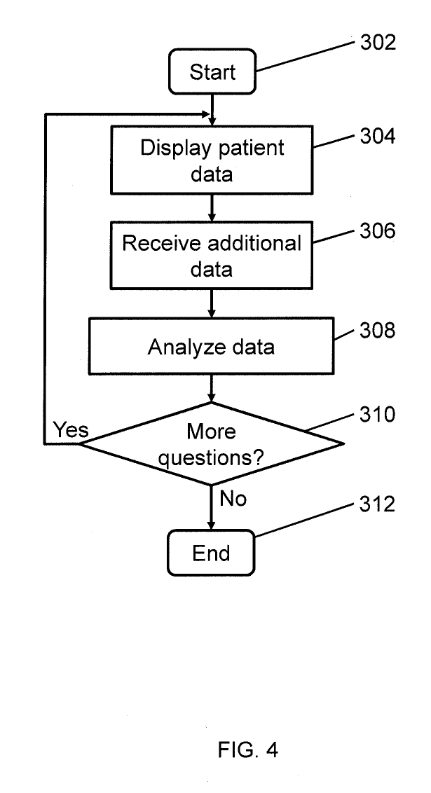

FIG. 4 is a flowchart illustrating a method of processing additional data obtained by a medical professional according to one embodiment of the present invention. In operation 304, the end-user device may initially display patient data received from the server 10. This patient data may include patient-supplied complaint and history information, a list of likely diagnoses as determined by the server, and a list of suggested further steps to take, e.g., taking readings of various signs, ordering particular lab tests, etc. During the course of the medical professional's interaction with the patient, the medical professional may supply additional data to the system. For example, blood pressure, pulse, and other evaluations of the patient may be entered into the system either manually using a user interface or automatically through electronic communications (e.g., over WiFi or Bluetooth connections) between the medical devices and the system. In addition, results of lab tests can also be automatically supplied to the system using existing electronic medical records systems. This additional data can be analyzed in operation 308 by the system in a manner similar to that described above with respect to FIG. 2 and operation 206. In operation 310, the server 10 may determine whether additional questions or procedures could be used to further refine the diagnosis. If so, then the patient data may be presented to the medical professional with an updated list of additional recommended diagnostics in operation 304. Otherwise, the process may end with, for example, a display of the latest analysis of the patient's condition.

After completion of clinical interactions, those clinical interactions with a patient after escalation (including additions and changes to the patient complaint profile) may be captured and fed back into the clinical decision support system so that the system may adjust the weights of various factors as appropriate in an adaptive learning system.

In addition, embodiments of the present invention provide a “mentoring” process for nurses and physicians to modify the system using the model editing user interface 116 to help tune the entire process to discover fast and reproducible methods for diagnosing and treating diseases, with various forms of hybrid voice and graphical widget tuning of the time course of symptoms, with the ability of the nurse and physician to track and over-ride the diagnoses provided by the system and to provide further specifications of signs, symptoms, and procedures associated with various diseases.

This mentoring process may be used to tune all aspects in the clinical setting, and once tuned, may be pushed out to consumers directly. The system may be further tuned using both advice nurse telephony, screen sharing, and chat/video technologies. By collecting information regarding the accuracy of information supplied at various stages of the data input process, the system can determine what sort of information may be reproducibly determined without staff assistance, what information generally needs the advice of a nurse, and which questions depend on face-to-face interactions for accurate evaluations of the symptoms. For example, the system may collect information that particular symptoms, signs, and indications that are initially supplied by a patient are frequently corrected to a different symptom by a nurse or doctor. As such, these particular signs, symptoms, and indications may be flagged as ones that are accurately and more reliably determined by medical professionals than by patients themselves and therefore questions relating to these signs, symptoms, and indications may be assigned to be asked later on by nurses and doctors rather than asked of the patients by the system.

Data viewed or entered at any given stage may be modified (e.g., by adding and removing signs, symptoms, and factors) by medical professionals based on their observations. These changes may be reviewed or aggregated with other entries to allow medical professionals to collaboratively refine the quality of the information stored in the system as medical professionals verify or identify problems with the stored information.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for diagnosing a patient using a computer system comprising a processor and memory storing a plurality of instructions to be executed on the processor, the method comprising:
receiving, on the computer system, information from the patient, the information comprising symptoms and symptom history;
identifying, on the computer system, a first set of diagnoses using the information;
dynamically presenting, from the computer system, the first set of diagnoses and a first set of questions to the patient in accordance with the information;
receiving, on the computer system, a first set of answers to the first set of questions; and
identifying, on the computer system, a second set of diagnoses and a second set of questions in accordance with the first set of answers.

2. The method of claim 1, wherein the identifying the first set of diagnoses using the information is performed using a neural network, a Bayesian network, or an expert system.

3. The method of claim 1, further comprising detecting a patient engagement metric, wherein the patient engagement metric comprises an amount of time spent answering the first set of questions.

4. The method of claim 3, further comprising displaying a final diagnosis and saving the first set of answers for further review if the patient engagement metric satisfies a threshold patient engagement level.

5. The method of claim 4, further comprising generating an alert after detecting that the patient engagement metric satisfies the threshold patient engagement level.

6. The method of claim 1, further comprising selecting the second set of questions in accordance with a preference of the patient determined from the first set of answers.

7. The method of claim 6, wherein the second set of questions comprises a narrative question or a direct question in accordance with the determined preference.

8. The method of claim 1, wherein the first set of answers comprises free form text.

9. The method of claim 1, wherein the identifying the second set of questions comprises selecting a question from a collection of questions in accordance with a likelihood that an answer to the selected question will distinguish between different ones of the second set of diagnoses.

10. The method of claim 1, further comprising generating an alert when a confidence level in the second set of diagnoses satisfies a threshold confidence level.

11. A system for diagnosing a patient, the system comprising:
a server comprising a processor and memory storing instructions configured to be executed on the processor and to cause the server to:
receive information from the patient, the information comprising symptoms and symptom history;
identify a first set of diagnoses using the information;
dynamically present the first set of diagnoses and a first set of questions to the patient in accordance with the information;
receive a first set of answers to the first set of questions; and
identify a second set of diagnoses in accordance with the first set of answers, the second set of diagnoses being a subset of the first set of diagnoses.

12. The system of claim 11, wherein the system is configured to identify the first set of diagnoses using the information is performed using a neural network, a Bayesian network, or an expert system.

13. The system of claim 11, wherein the instructions further comprise instructions configured to be executed on the processor and to cause the server to: detect a patient engagement metric, wherein the patient engagement metric comprises an amount of time spent answering the first set of questions.

14. The system of claim 13, wherein the instructions further comprise instructions configured to be executed on the processor and to cause the server to: display a final diagnosis and saving the first set of answers for further review if the patient engagement metric satisfies a threshold patient engagement level.

15. The system of claim 14, wherein the instructions further comprise instructions configured to be executed on the processor and to cause the server to: generate an alert after detecting that the patient engagement metric satisfies the threshold patient engagement level.

16. The system of claim 11, wherein the instructions further comprise instructions configured to be executed on the processor and to cause the server to: identify a second set of questions in accordance with a preference of the patient determined from the first set of answers.

17. The system of claim 16, wherein the second set of questions comprises a narrative question or a direct question in accordance with the determined preference.

18. The system of claim 16, wherein the second set of questions are identified by selecting a question from a collection of questions in accordance with a likelihood that an answer to the selected question will distinguish between different ones of the second set of diagnoses.

19. The system of claim 11, wherein the first set of answers comprises free form text.

20. The system of claim 11, wherein the instructions further comprise instructions configured to be executed on the processor and to cause the server to generate an alert when a confidence level in the second set of diagnoses satisfies a threshold confidence level.
